(19) United States
(12) Patent Application Publication
(10) Pub. No.: US 2019/0358847 A1
(43) Pub. Date: Nov. 28, 2019

(54) METHOD AND DEVICE FOR DIVIDING PANEL-SHAPED WORKPIECES

(71) Applicant: Ima Klessmann GmbH Holzbearbeitungssysteme, Lübbecke (DE)

(72) Inventors: Thomas Herold, Bückeburg (DE); Ralf Schürmann, Stemwede (DE)

(73) Assignee: Ima Klessmann GmbH Holzbearbeitungssysteme, Lübbecke (DE)

(21) Appl. No.: 16/467,650

(22) PCT Filed: Dec. 8, 2017
(86) PCT No.: PCT/EP2017/082083

§ 371 Date: Jun. 7, 2019

(30) Foreign Application Priority Data
Dec. 9, 2016 (DE) 10 2016 014 682.6

(51) Int. Cl. B27B 5/065

(52) U.S. Cl. CPC B27B 5/065

(57) ABSTRACT

A method for dividing panel-shaped workpieces, which comprise wood or a wood substitute substance as a material, into in each case a plurality of smaller workpieces. A panel-shaped workpiece that is to be divided is initially divided by saw cuts into a plurality of rectangular strip-shaped workpieces with a first pair of opposing narrow sides and a second pair of opposing narrow sides, the first narrow sides being longer than the second narrow sides. In a further method step, the strip-shaped workpieces are divided by a plurality of milling tools simultaneously with cuts parallel to the second narrow sides into the smaller workpieces.

### CROSS REFERENCE TO RELATED APPLICATIONS

This application is the US National Phase of and claims the benefit of and priority on International Application No. PCT/EP2017/082083 having an international filing date of 8 Dec. 2017, which claims priority on German Patent Application No. 10 2016 014 682.6 having a filing date of 9 Dec. 2016.

### BACKGROUND OF THE INVENTION

### Technical Field

The invention relates to a method and a device for dividing planar workpieces, which workpieces preferably comprise wood or a wood substitute material as the material, into a plurality of smaller workpieces in each case.

In many fields of industry, the problem arises of dividing planar workpieces, which are produced by the manufacturer in a comparatively large format, into smaller planar workpieces, the dimensions of which correspond to those in which the planar workpieces are actually required. In this case, the smaller workpieces that result from the division are often themselves semi-finished products, for example in the manufacture of furniture, in which the smaller planar workpieces are assembled for example into carcasses or form rear walls of items of furniture. However, numerous other use situations also exist, in which large planar workpieces must be divided correspondingly into smaller planar workpieces.

In this case, the planar workpieces are generally workpieces consisting of wood or wood substitute materials, such as chipboard, HDF or MDF boards, laminates, or multilayer materials consisting of the above-mentioned and/or other substances.

### Prior Art

According to the prior art, various methods exist for dividing planar workpieces of this kind. In particular sawing methods should be noted in this case, which methods are characterized by a high level of cutting performance and thus high processing capacities of the sawing apparatuses. The disadvantage of sawing methods of this kind is that the geometries of the possible cutting plans are restricted. In general, a saw can perform only straight cuts.

In order to now achieve complex cutting plans, planar workpieces of the type in question can also be cut using milling tools. Said tools can achieve almost any desired straight or curved, but also angled, cutting lines in the main extension plane of a planar workpiece of this kind. An example for a method of this kind is disclosed for example in DE 10 2013 007 556 A1. Very complicated cutting plans can be achieved thereby, which is advantageous in particular in view of preventing waste, and the resulting losses, as far as possible. However, said methods do not achieve the high processing speeds of saws.

According to the prior art, methods and devices are therefore known that combine saw cuts and cuts using milling tools. For example, EP 2 147 761 A2 discloses a method in which a narrow side of a planar workpiece to be divided is first profiled using a milling tool, such that a zigzag-shaped cut results in a stepped course of the narrow side, in the plane of extension of the planar workpiece to be divided. Strip-shaped workpieces are then separated from said planar workpiece by means of a saw. Said strip-shaped workpieces are then divided into smaller workpieces using mutually parallel saws, by means of the spacings between the saws being oriented to the stepped profiling, such that the desired number of smaller workpieces results.

Although a method of this kind already allows for a comparatively flexible design of cutting plans, the sawing technique can display the advantage of the high processing capacity only to a limited extend, because, depending on the complexity of the cutting plan to be produced, the milling tool for profiling the workpiece may sometimes slow down the processing time, such that in particular the saws that divide the strip-shaped workpieces into the smaller sheets are utilized only to a limited extent.

### BRIEF SUMMARY OF THE INVENTION

The object of the invention is therefore that of specifying a method and a device which allow for a high processing speed when dividing large-format sheets, but also allow for cutting plans to be achieved in a manner having little waste.

The object is achieved by a method and a device having the features of the independent claims. The features of the dependent claims relate to advantageous embodiments.

According to the method according to the invention for dividing planar workpieces into a plurality of smaller workpieces in each case, a planar workpiece to be divided is first cut into a plurality of rectangular, strip-shaped workpieces by means of saw cuts. The strip-shaped workpieces comprise a first pair of mutually opposing narrow sides and a second pair of mutually opposing narrow sides, the first narrow sides, i.e. the narrow sides of the first pair of mutually opposing narrow sides, being longer than the second narrow sides, i.e. the narrow sides of the second pair of mutually opposing narrow sides.

According to the invention, in a further method step the strip-shaped workpieces are then divided simultaneously into the smaller workpieces, by means of a plurality of milling tools in each case. In this case, the cuts are made in parallel with the second narrow sides. Said further method step takes place temporally after sawing up the in particular large-format, planar workpiece to be divided. In this case, the initial sawing down of strip-shaped workpieces takes place such that the saw cuts are preferably performed over the entire width of the large-format initial workpiece. It is in particular preferable, in this case, for each strip-shaped workpiece to first be provided with backward cuts by means of the milling tool, or for the milling tool to machine portions of the strip-shaped workpiece that are not required, after the large-format sheet has been sawn up into strip-shaped workpieces. Subsequently, the further division is then preferably performed by the plurality of milling tools, as a result of which customized workpieces are then produced, and/or waste, which can then be supplied to further processing, can be machined in the edge region. According to a preferred embodiment, firstly in each case a strip is separated from the large-format planar workpiece, in the manner described above, by sawing, and said strip is subsequently divided, in the manner described, by means of the milling tool. The division can take place temporally before the separation, achieved by saw, of a further strip from the large-format planar workpiece, or can take place simultaneously.

It has been found that this combination of saw cuts and cuts using milling tools makes it possible not only to achieve high performance, but also for the cutting plans to be designed in a very flexible manner.

The device according to the invention for dividing planar workpieces into a plurality of smaller workpieces in each case thus comprises a sawing apparatus for dividing planar workpieces into a plurality of strip-shaped workpieces in each case. The sawing apparatus is designed such that it can perform cuts in a first direction. Said apparatus is preferably a circular saw. This has the advantage of achieving relatively high cutting performance in the case of straight cuts.

The device, in particular the sawing apparatus, is designed such that the sawing apparatus can perform the saw cuts in a first direction. In the case, the workpiece lies preferably still, relative to the device. Particularly preferably, the planar workpiece lies still in and/or on a supply means for supplying the workpieces to the sawing apparatus. This may for example be a saw bench. In this case, the saw bench preferably comprises suitable conveying and/or positioning means in order to preferably automatically orient the planar workpiece correctly with respect to the sawing apparatus, or to convey said workpiece from one saw cut position to the next, between the individual saw cuts being performed.

According to the invention, the device comprises a milling apparatus comprising a plurality of milling tools for dividing the strip-shaped workpieces into smaller workpieces by means of a plurality of cuts that are made simultaneously. In this case, the device, in particular the milling apparatus, is preferably designed such that the cuts can be made in parallel with a second direction that is oriented so as to be at least substantially perpendicular to the first direction.

The device advantageously comprises an intermediate storage means for intermediate storage of the strip-shaped workpieces. Said intermediate storage means is preferably arranged in the second direction, between the sawing apparatus and the milling apparatus. Accordingly, according to a preferred embodiment of the method according to the invention, after division of the planar workpieces, the strip-shaped workpieces are first conveyed into an intermediate storage means for intermediate storage of the workpieces, while at the same time strip-shaped workpieces are conveyed out of the intermediate storage means and fed to the process of division by the milling tools. In this case, the strip-shaped workpieces are preferably conveyed into the intermediate storage means and/or out of the intermediate storage means in a direction that is at least substantially in parallel with the second narrow sides.

In the context of the present invention, but in particular in the context of the intermediate storage means, “at least substantially in parallel” means, primarily, that in particular minor deviations from exact parallelism between the course of the narrow sides and the conveying directions, resulting for example from the design of conveying means that are used, and which for example cause height differences along the conveying path, should not be of significance.

The intermediate storage means of the device according to the invention is in particular designed in accordance with the FIFO (first-in-first-out) principle. This means that, in a manner analogous to the method according to the invention, the workpiece that is conveyed first into the intermediate storage means is also the first to be guided out of said means again, while the strip-shaped workpiece that is conveyed into the intermediate storage means second is also the second to be conveyed out of said means. The corresponding situation applies analogously for each further strip-shaped workpiece.

It is in principle also possible to design the intermediate storage means such that continuous transport takes place from the sawing apparatus to the milling apparatus. This means, for example, providing a sufficiently long transport path between the sawing apparatus and the milling apparatus, which path is long enough that a plurality of strip-shaped workpieces can be transported on said transport path simultaneously.

In this case, a design of said transport path which makes it possible to adapt the transport speeds of the individual strip-shaped workpieces such that the transport path can act as a type of “buffer” for different pulse settings of the sawing apparatus and the milling apparatus, is advantageous. The strip-shaped workpieces that are stored on the transport path in this manner thus make it possible to mutually compensate different cycle times, varying from workpiece to workpiece, of the sawing apparatus and the milling apparatus. That is to say that, if the sawing apparatus generates strip-shaped workpieces in shorter intervals than those in which the milling apparatus can divide said workpieces further, the number of strip-shaped workpieces in the intermediate store increases and/or the spacings between the strip-shaped workpieces on the transport path acting as the intermediate store are reduced. In contrast, if the cycle time of the sawing apparatus exceeds that of the milling apparatus, the number of workpieces in the intermediate store reduces, and in particular the spacings between the transported workpieces can be increased, on a correspondingly designed transport path acting as an intermediate store, for example by increasing the conveying speed relative to the cycle time of the sawing apparatus.

According to an advantageous embodiment of the method according to the invention, when dividing the planar workpiece, a saw cut, which ends in the workpiece, is performed between two saw cuts, proceeding from one of the second narrow sides of a strip-shaped workpiece resulting from the division of the planar workpiece. Performing cuts of this kind means that the sawing apparatus can be used not only to divide the planar workpiece, to be divided, into strip-shaped workpieces, but also to assist the further division of the strip-shaped workpieces into smaller workpieces. When divided by the milling apparatus or the milling tools into the smaller workpieces, the strip-shaped workpieces, comprising the saw cuts that are made in this way, are divided such that the end of the saw cut that ends in the workpiece ends in a region of the workpiece that is to be machined by a milling tool. Cutting guidance of this kind is advantageous in particular when the saw cut is connected to one of the two first narrow sides of the strip-shaped workpiece by means of a cut using a milling tool. It is thus possible for smaller workpieces to be produced from the strip-shaped workpieces using fewer milling cuts, and thus processing time is saved in the case of cutting plans suitable for this. It is also possible, in this way, to remove waste in a simple manner, which waste generally cannot be completely prevented, even in the case of more complex cutting plans.

The method according to the invention and/or the device according to the invention can be used particularly advantageously in what is known as “one-piece flow manufacturing”, i.e. manufacturing in which individual components are manufactured in a customized manner. In this case, the smaller planar workpieces generally constitute the semi-finished products for further processing and must be provided in a plurality of very varied quantities. A superordinate control means can advantageously distribute the quantity of the smaller workpieces, to be created, over the cutting plans so as to result in a cutting plan, for each planar workpiece to be divided, that is optimized in accordance with processing times and/or prevention of waste. The cutting plans thus calculated are then used further for controlling the device according to the invention and/or for performing the method according to the invention.

A further advantageous variant of the method according to the invention is that of performing the method for example using a plurality of, e.g. two, planar workpieces on top of one another. In particular in the case of comparatively thin planar workpieces, significantly more efficient manufacture can be achieved thereby, if the power of the sawing apparatus or of the milling apparatus is sufficient for cutting through a plurality of said planar workpieces simultaneously. In these cases, the same cutting plans are preferably achieved using the workpieces that are on top of one another in each case.

A further advantageous variant consists in performing cuts, using the milling apparatus and/or sawing apparatus, such that the planar workpiece is not completely cut through in the thickness direction thereof. In this way, local linear material weakening, for example grooves, are made in the planar workpiece. These can then be used, for example, in order to produce rear walls, for furniture production, that can be folded along a line.

It is furthermore possible to use the milling tools to perform additional machining on the workpieces, for example to introduce profiling and/or receptacles, for example for fitting elements or furniture hinges, into the smaller planar workpieces.

In particular in view of “one-piece flow manufacturing”, a variant of the present invention is advantageous in which the supply means for supplying the workpieces to the sawing apparatus comprises a pivot means for pivoting the planar workpieces. Said pivot means is preferably designed such that it can pivot the workpieces about a vertical axis and/or about an axis that is at least substantially in parallel with the thickness direction of the workpiece. Both axes are well suited for technical implementation of a rotation of the workpiece. If the saw bench is arranged horizontally, i.e. the workpiece is fed having the main extension directions thereof in a horizontal plane of the device, the axes may coincide, i.e. an axis in parallel with the thickness direction of the workpiece is also a vertical axis.

A pivot means of this kind makes it possible to achieve even more complex cutting plans. It is thus possible to separate some strip-shaped workpieces from a planar workpiece to be divided, and to then rotate said strip-shaped workpieces about 90°, in order to then divide further strip-shaped workpieces out of the workpiece that is to be divided. The strip-shaped workpieces separated prior to the rotation are then oriented, in the cutting plan, in a manner rotated about 90° relative to the strip-shaped workpieces separated after the rotation. According to an advantageous embodiment, the device comprises a feed means for generating the feed movement of the strip-shaped workpieces during the division thereof by the milling tools. As a result of a feed movement of this kind, the milling tool itself does not need to be movable in the feed direction that can be achieved by said feed means, which significantly simplifies the construction of the device according to the invention. The feed direction is preferably a second direction that is substantially at right angles to the first direction. In the case of a machine oriented in this manner, the boards can be conveyed from the supply to the sawing apparatus as far as the milling apparatus in an at least largely straight movement, i.e. in particular substantially in one direction. Any means for changing the orientation of the workpieces between the individual division apparatuses can thus be omitted, and it is possible to construct devices that are particularly compact and simultaneously high-performance.

The feed means preferably comprises a plurality of gripping elements for gripping the edge region of the conveyed strip-shaped board that is directed counter to the conveying direction. A feed means of this kind can advantageously fix the strip-shaped workpiece in the region of the narrow side directed counter to the conveying direction, and thus push said workpiece “spontaneously” through the milling apparatus. In this case, the gripping elements can preferably be positioned along a stretch, such that the mutual spacings of the gripping elements can be varied when said elements grip the workpiece. The stretch along which the gripping elements can be positioned is preferably oriented so as to be in parallel with the first direction. In this way, the strip-shaped workpiece separated by the saw can maintain its orientation until the milling. The positioning of the gripping elements makes it possible to place said elements such that they at least do not disturb, but in particular assist, the processing according to the cutting plan specified in each case.

In particular, at the moment when the milling tool completely cuts through the workpiece, in view of clean cutting guidance, secure fixing of the workpiece, in particular by the gripping elements, is advantageous for the cleanness of the cuts. According to a preferred embodiment, the device according to the invention comprises at least one, but preferably a plurality of, gripping elements, which are designed in an advantageous manner. An advantageous gripping element of this kind comprises a first and a second clamping region which come to rest on opposing flat sides of the workpiece. The workpiece is clamped between said clamping regions.

In the case of the advantageous gripping elements, the first and/or the second clamping region comprises a recess. A milling tool can be moved in said recess, relative to the gripping elements, when dividing a strip-shaped workpiece into the smaller workpieces. In this case, the workpiece is preferably clamped between the clamping regions such that the narrow side of the workpiece is cut through in the region of the recess, i.e. the workpiece is divided, when the milling tool is moved in the recess. The two parts of the first and/or second clamping region that are divided by the recess and are in contact with the workpiece then each retain one of the smaller workpieces, respectively, that are created by the separation of the strip-shaped workpiece using the milling apparatus. Since the new workpieces thus created are retained by different parts of the same clamping region, in the immediate vicinity of the milling tool, clamping thus results that is rigid and thus promotes the cleanness of the cut. A further advantages is the fact that just one gripping element is required in the region of each split cut in order to ensure clean emergence of the milling tool from the workpiece. It is not necessary to use two gripping elements to grip either side of the point at which the milling tool emerges from the narrow side when the workpiece is cut through finally.

It is particularly advantageous for the milling tools to be displaceable along the milling apparatus. This allows for further variations of the cutting plans, since it is thus possible for the milling tools to perform cuts in an additional direction. In this connection, it is particularly advantageous for the milling tools to be displaceable along the milling apparatus in a direction that is at least substantially in parallel with the first direction. This advantageously allows for positioning and/or feed movements of the milling tools.

### BRIEF DESCRIPTION OF THE DRAWINGS

The invention will be explained schematically in greater detail in the following, with reference to FIGS. 1 to 5.

FIG. 1 is a schematic view of a method according to the invention, given by way of example.

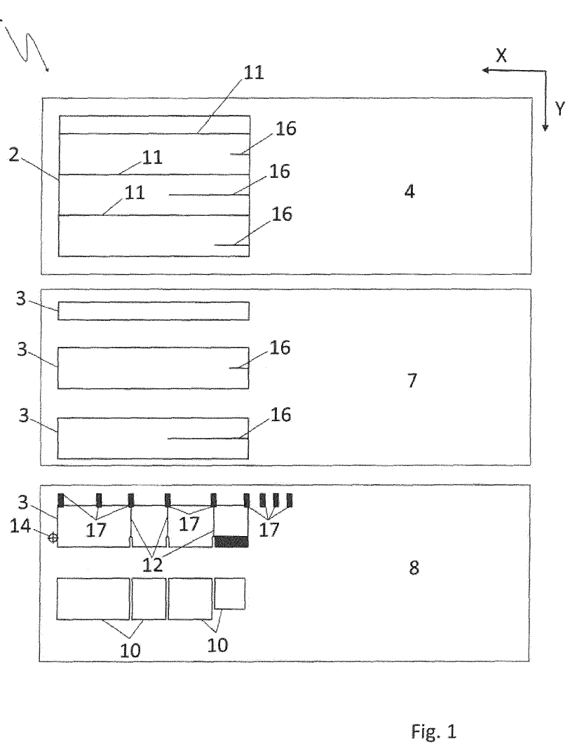

FIG. 2 is a highly simplified schematic view of a device according to the invention.

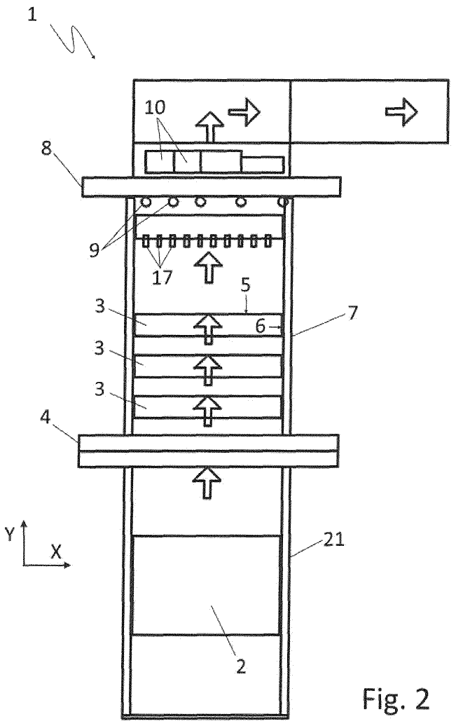

FIG. 3 is a detailed drawing of a device according to the invention, given by way of example.

FIG. 4 shows a cutting plan, by way of example, that can be achieved using a device according to the invention or a method according to the invention.

FIG. 5 is a detailed drawing of a gripping means of a device according to the invention, given by way of example.

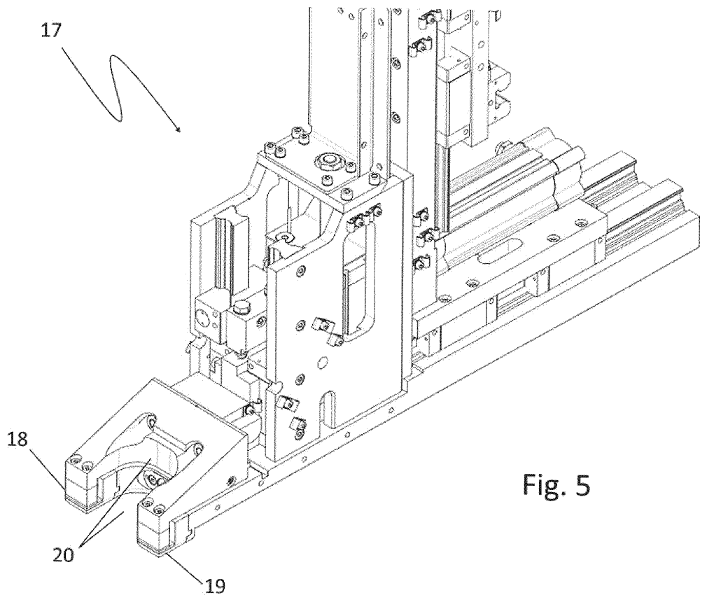

FIGS. 6 and 7 schematically show the operating principle of the gripping means shown in FIG. 5.

### DETAILED DESCRIPTION OF PREFERRED EMBODIMENTS

The device 1 according to the invention, given by way of example, comprises a sawing apparatus 4 for dividing the planar workpieces 2, to be divided, into the strip-shaped workpieces 3. In the example shown, the sawing apparatus 4 divides the planar workpieces 2 in a first direction X, such that strip-shaped workpieces 3 comprising a first pair of longer narrow sides 5 and a pair of shorter narrow sides 6 result. In the example shown, the long narrow sides 5 are advantageously oriented in the first direction X and advantageously retain this orientation in the further course of the method.

The workpieces are first conveyed from the sawing apparatus 4 into an intermediate storage means 7. In the example shown, this is advantageously designed in accordance with the FIFO principle, i.e. the strip-shaped workpieces 3 that are first to reach the intermediate storage means 7 are also the first to leave the intermediate storage means 7 when supplied to the process of division by the milling apparatus 8. In the milling apparatus 8, the strip-shaped workpieces 3 are divided into the smaller workpieces 10 using a plurality of milling tools 9.

In this case, the device 1 according to the invention is advantageously designed so as to perform the saw cuts 11 in a first direction X. The cuts 12 using the milling tools, which cuts are oriented so as to be perpendicular to the saw cuts, are correspondingly performed in parallel with a second direction Y that is perpendicular to the first direction X. For this purpose, the strip-shaped workpieces 3 are moved in the second direction Y using a feed means 13. The device according to the invention, given by way of example, additionally comprises a milling tool 14 that is preferably immovable in the first direction X. The further milling tools 9 are advantageously received on the milling apparatus 8 so as to be movable in the first direction X. This allows for cuts 15 by the milling tools 9 that preferably extend in parallel with the saw cuts 11.

The milling tool 14 is used to ensure a clean workpiece edge by means of material removal at an edge region of the strip-shaped workpieces 3 that also corresponds to an edge region of the original planar workpiece 2. Accordingly, the method according to the invention can advantageously provide for narrow strips to be separated, at the edge regions of the planar workpiece 2, by means of saw cuts 11, which narrow strips constitute waste, in order to ensure clean edge regions of the resulting smaller workpieces 10 here too. This is advantageous in particular if the edge regions of the planar workpieces 2 are not of the necessary quality that is required of the edge regions of the smaller workpieces 10.

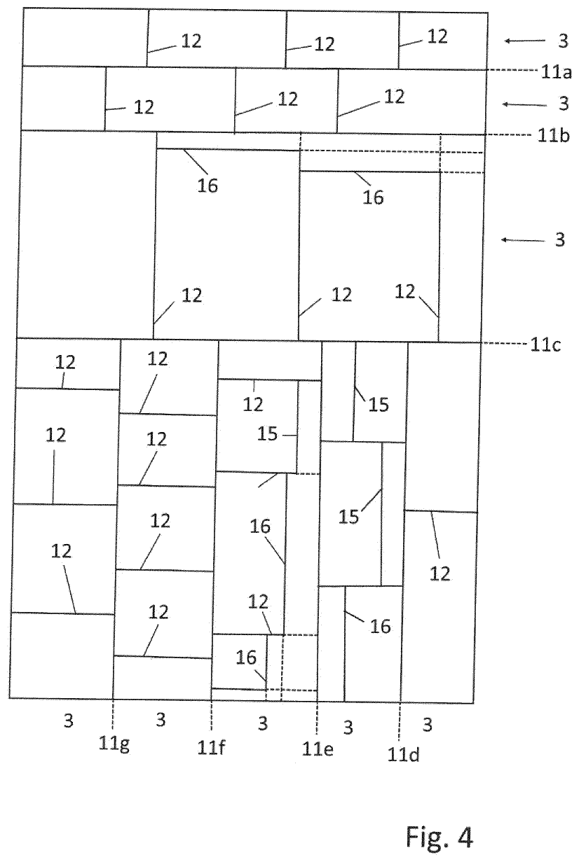

The sawing apparatus can also perform saw cuts 16 that end in the workpiece 4. As a result, processing time can advantageously be saved when implementing complex cutting plans. A complex cutting plan of this kind, given by way of example, is shown in FIG. 4. When implementing said cutting plan on a device 1 according to the invention, strip-shaped workpieces 3 are first separated from a planar workpiece 2 by means of the saw cuts 11a, 11b and 11c. In this case, the sawing apparatus 4 performs additional saw cuts 16 that end in the workpiece. When dividing the resulting strip-shaped workpieces 3 by means of cuts using the milling tool 9, the ends of the saw cuts 16 are connected to the narrow sides of the strip-shaped workpieces. In FIG. 4, the cuts 12 by the milling tools 9 and the saw cuts 16 that extend through regions of the workpiece and that constitute waste at a later time, are shown by dashed lines.

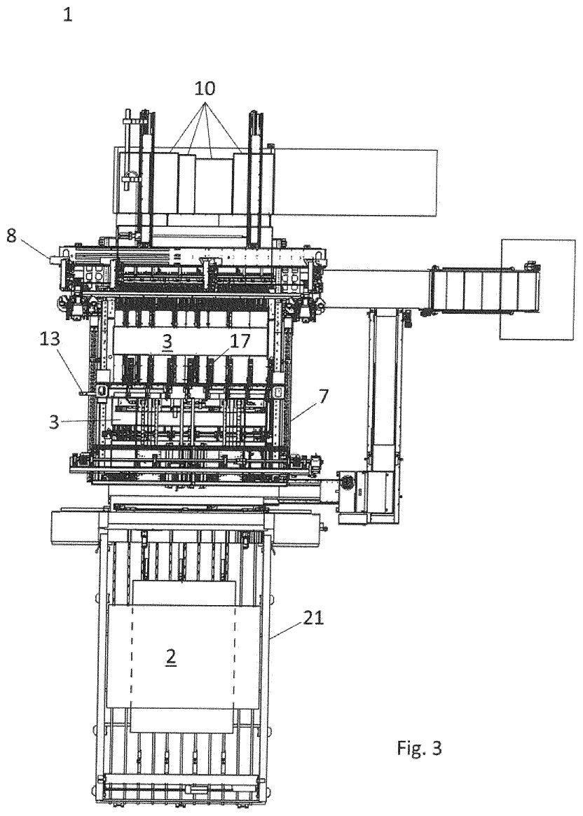

In the example shown, the device 1 according to the invention advantageously comprises a supply means 21 comprising a pivot means that is not shown in greater detail. The planar workpieces 2 can be pivoted thereby, about an axis in parallel with the thickness direction of said workpieces, prior to being supplied to the sawing apparatus 4. For the purpose of clarification, FIG. 3 shows the planar workpiece 2 by way of example in two possible, mutually perpendicular, orientations. In this way, in the cutting plan by way of example that is shown in FIG. 4, after the saw cuts 11a, 11b and 11c have been performed, the saw cuts 11d, 11e, 11f and 11g can be made, by means of the planar workpiece being pivoted about 90° after the saw cut 11c has been performed and before the further saw cuts are performed.

In the cutting plan given by way of example, the strip-shaped workpiece located between the saw cuts 11d and 11e comprises cuts 15 that extend in parallel with the saw cuts 11 but are made by the milling tools 9. This is advantageously achieved by means of the milling tools 9 being moved along the milling apparatus 8, preferably in parallel with the first direction X. The waste can be reduced yet further thereby.

It is particularly advantageous, in connection with the device 1 according to the invention, given by way of example, for the feed means 13 to comprise a plurality of gripping elements 17. The gripping elements 17 can preferably be positioned along the feed means 13. In this case, the direction in which the gripping elements 17 can be positioned along the feed means 13 is preferably oriented so as to be in parallel with the first direction X. In this case, the gripping elements 17 are designed such that they can preferably grip a strip-shaped workpiece 3 in the region of the narrow side of the strip-shaped workpiece 3 that is directed counter to the conveying direction. This is preferably one of the long narrow sides 5 of the strip-shaped workpiece 3.

The gripping elements 17 preferably comprise a first clamping region 18 and a second clamping region 19 for resting on one of the flat sides, respectively, of the strip-shaped workpiece 3.

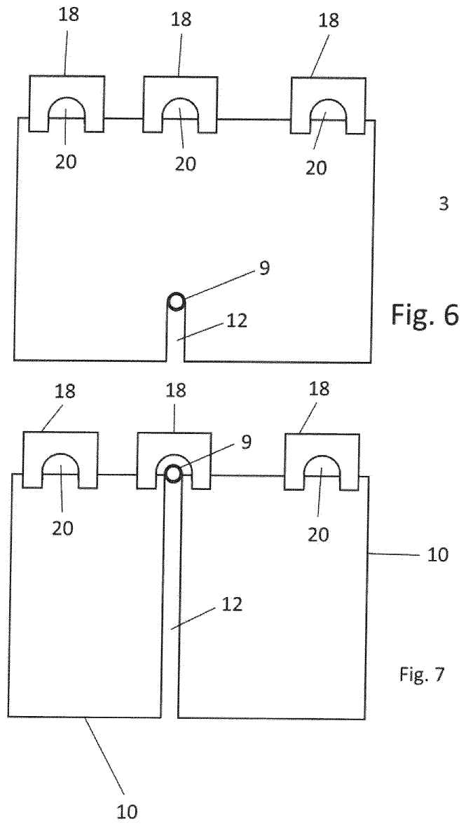

Particularly preferably, the first clamping region 18 and/or the second clamping region 19 comprise a recess 20 in which a milling tool 9 can be moved when dividing a strip-shaped workpiece 3. This procedure is shown schematically in particular in FIGS. 6 and 7. The advantageous embodiment shown, comprising the recesses 20 in the clamping regions, makes it possible for the clamping regions to clamp the workpiece on both sides of the milling tool 9 emerging from the cut. As a result, the number of gripping elements 17 required is reduced, and the two sides of the cut are fixed in position, relative to one another, in an extremely rigid manner by means of the common clamping region 18 and 19, such that particularly clean cuts result. In this case, the recess 20 virtually divides the surfaces of the first clamping region 18 and/or second clamping region 19, adjacent to the strip-shaped workpiece 3, into two surfaces which together fix the strip-shaped workpiece 3 prior to the strip-shaped workpiece 3 being cut through finally, and each fix one of the resulting adjacent smaller workpieces 10, respectively, after the strip-shaped workpiece 3 has been cut through.

1. (canceled)

2. (canceled)

3. (canceled)

4. (canceled)

5. (canceled)

6. (canceled)

7. (canceled)

8. (canceled)

9. (canceled)

10. (canceled)

11. A method for dividing planar workpieces (2), which workpieces comprise wood or a wood substitute material as the material, into a plurality of smaller workpieces (10) in each case, a planar workpiece (2) to be divided first being cut, by means of saw cuts (11), into a plurality of rectangular, strip-shaped workpieces (3) each comprising a first pair of opposing narrow sides (5) and a second pair of opposing narrow sides (6), the first narrow sides (5) being longer than the second narrow sides (5),
the strip-shaped workpieces (3) being divided simultaneously, in a further method step, into the smaller workpieces (10), by means of cuts in parallel with the second narrow sides (6), using a plurality of milling tools (9),
wherein, after the division of the planar workpiece (2), the strip-shaped workpieces (3) are first conveyed, preferably in a direction that is at least substantially in parallel with the second narrow sides (6), into an intermediate storage means (7) for intermediate storage of the strip-shaped workpieces (3), while at the same time strip-shaped workpieces (3) are conveyed, preferably in a direction that is at least substantially in parallel with the second narrow sides (6), out of the intermediate storage means (7) and fed to the process of division by the milling tools (9).

12. The method according to claim 11,
wherein, when dividing the planar workpiece (2), a saw cut (16), which ends in the workpiece, preferably in a region of the workpiece that is subsequently to be machined during division of the strip-shaped workpiece (3) by a milling tool (9), is performed between two saw cuts (17), proceeding from one of the second narrow sides (6) of a strip-shaped workpiece (3) resulting from the division of the planar workpiece (2), in particular a cut performed when dividing the strip-shaped workpiece (3) by means of a milling tool (9) connecting the saw cut (16) with one or both of the first narrow sides (5).

13. A device (1) for dividing planar workpieces (2), which workpieces comprise wood or a wood substitute material as the material, into a plurality of smaller workpieces (10) in each case, in particular according to a method of the preceding claims, said device comprising a sawing apparatus (4) for dividing the planar workpieces (2) into a plurality of strip-shaped workpieces (3) in each case by means of saw cuts (11) in a first direction (X),
the device comprising a milling apparatus (8) comprising a plurality of milling tools (9) for dividing the strip-shaped workpieces (3) into the smaller workpieces (10) by means of a plurality of cuts (12) that are made simultaneously, in particular in parallel with a second direction (Y) that is at least substantially perpendicular to the first direction (X),
wherein, the device (1) preferably comprises an intermediate storage means (7) which is arranged in the second direction (Y), between the sawing apparatus (4) and the milling apparatus (8), and is intended for intermediate storage of the strip-shaped workpieces (3), in particular the intermediate storage means (7) being designed in accordance with the FIFO principle, the milling apparatus (8) being arranged so as to be spatially separated from the sawing apparatus (4).

14. The device (1) according to claim 13,
wherein, the device comprises a supply means (21) for supplying the workpieces to the sawing apparatus (4), in particular the supply means (21) comprising a pivot means for pivoting the planar workpieces (2) about a vertical axis and/or about an axis that is at least substantially in parallel with the thickness direction of the planar workpiece (2).

15. The device (1) according to either claim 13,
wherein, the device comprises a feed means (13) for generating the feed movement of the strip-shaped workpieces (3), in particular in second direction (4) that is at least substantially at right angles to the first direction (X), during the division of said workpieces by the milling tools (9).

16. The device (1) according to claim 15,
wherein, the feed means (13) comprises a plurality of gripping elements (17), which elements can in particular be positioned along the feed means (13), preferably in a direction in parallel with the first direction (X), for gripping a conveyed strip-shaped workpiece (3), in particular in the region of the narrow side of the strip-shaped workpiece (3) that is directed counter to the conveying direction.

17. The device (1) according to claim 16,
wherein, in order to grip the conveyed workpiece, at least one, preferably a plurality of, gripping element(s) (17) of the feed means (13) comprises a first clamping region (18) for resting on a first flat side of the strip-shaped workpiece (3) and a second clamping region (19) for resting on a second flat side of the conveyed strip-shaped workpiece (3) that is opposite the first flat side, the first clamping region (18) and/or the second clamping region (19) comprising a recess (20) in which a milling tool can be moved, relative to the gripping element (17), when dividing a strip-shaped workpiece (3) into the smaller workpieces (10).

18. The device (1) according to claim 13,
wherein, the milling tools (9) are displaceable along the milling apparatus (8), in particular in a direction that is at least substantially in parallel with the first direction (X).
